(19) United States
(12) Patent Application Publication
(10) Pub. No.: US 2004/0004923 A1
(43) Pub. Date: Jan. 8, 2004

(54) Optical disk apparatus and method of controlling optical disk rotational speed

(75) Inventors: Shigetoshi Hirai, Hiratsuka-shi (JP); Shigeo Tsuchiya, Yokohama-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/448,321

(22) Filed: May 30, 2003

(30) Foreign Application Priority Data
May 31, 2002 (JP) 2002-158900

(51) Int. Cl. G11B 7/00

(52) U.S. Cl. 369/53.28; 369/53.37

(57) ABSTRACT

An optical disk apparatus includes rotating mechanisms which rotate an optical disk, recording functions which irradiate the optical disk with a laser beam to perform recording processing, a measuring circuit which measures a focus error signal FE caused by the irradiation with the laser beam, and a rotational speed setting circuit which controls speed of the optical disk on the basis of a value of the focus error signal so as to properly decrease the speed of the optical disk. The rotational speed is decreased corresponding to distortion of the optical disk, so that a servo can follow the distortion and the stable recording processing can be performed.

### CROSS-REFERENCE TO RELATED APPLICATIONS

This application is based upon and claims the benefit of priority from the prior Japanese Patent Application No. 2002-158900, filed May 31, 2002, the entire contents of which are incorporated herein by reference.

### BACKGROUND OF THE INVENTION

1. Field of the Invention

The present invention relates to an optical disk apparatus, particularly relates to an optical disk apparatus in which a recording speed is controlled on the basis of a focus error signal or the like, and a method of controlling an optical disk rotational speed.

2. Description of the Related Art

In recent years, an optical disk apparatus using an optical disk is rapidly becoming widespread, high performance is required for recording characteristics. A mechanical shape of a removable medium such as an optical disk is not always ideal, there are also many media having distortion. When the distortion exceeds a certain extent, the recording characteristics are affected by the distortion. In particular, when the recording is performed at higher double-speed by using the disk having the distortion, since a servo can not follow with sufficient accuracy, it is known that a failure of the recording or a worsening of a recording status easily occurs.

A reproducing apparatus of the optical disk is shown in Jpn. Pat. Appln. KOKAI Publication No. 11-213413. In the disclosed reproducing apparatus of the optical disk, a peak value of a tracking error signal of the optical disk is detected, and reading error is avoided while the number of revolutions is controlled corresponding to the detected peak value.

However, there is no recording method in which the distortion of the optical disk is considered while the recording is performed into the optical disk. In the conventional apparatus, when the recording is performed by using the optical disk which has the distortion more than a certain extent, the servo can not follow with sufficient accuracy, so that the failure of the recording or the worsening of the recording status easily occurs.

That is, in the conventional apparatus, when the recording is performed by using the optical disk which has the distortion more than the certain extent, the servo can not follow with sufficient accuracy, so that the failure of the recording or the worsening of the recording status easily occurs, as a result, there is a problem that the high-reliable recording processing can not be performed by using such an optical disk.

### BRIEF SUMMARY OF THE INVENTION

According to an embodiment of the present invention, an optical disk apparatus comprises a rotating motor which rotates the optical disk at a predetermined speed; a recording portion which irradiates the optical disk with a laser beam generated corresponding to given information to perform recording processing; a measuring circuit which measures the focus error signal caused by the irradiation with the laser beam of the recording portion; a determination portion which determines whether or not the predetermined speed of the rotating motor is decreased on the basis of a value obtained from the focus error signal measured with the measuring circuit; and a speed control portion which decreases the predetermined speed of the rotating motor corresponding to the value determined by the determination portion.

In the embodiment, a residual of the focus error signal is detected during the recording by the constitution described above, when the distortion of the extent in which the servo can not follow is generated in the disk, the rotational speed of the disk is decreased corresponding to the distortion, and the recording processing is continued. Consequently, the servo can follow the distortion of the disk, and the recording error or the worsening of the recording state can be avoided.

Not only the focus error signal, but also a tracking error signal becomes a subject of reference physical quantity, so that the distortion of the disk can be detected with higher accuracy.

### BRIEF DESCRIPTION OF THE SEVERAL VIEWS OF THE DRAWING

FIG. 1 is a block diagram showing an example of a configuration of an optical disk apparatus according to one embodiment of the invention;

FIG. 2 is a sectional view showing an example of a constitution of an optical pickup device in the optical disk apparatus according to one embodiment of the invention;

FIG. 3 is a view of a shape for explaining a warp of an optical disk which is handled by the optical disk apparatus according to one embodiment of the invention;

FIG. 4A is a waveform of a focus error signal in the case where the optical disk apparatus according to one embodiment of the invention traces the optical disk having the warp;

FIG. 4B is a waveform of a tracking error signal in the case where the optical disk apparatus according to one embodiment of the invention traces the optical disk having the warp;

FIG. 5 is a graph illustrating a change in a servo gain caused by the change in the number of revolutions of the optical disk apparatus; and

FIG. 6 is a flow chart in the case where the number of revolutions is changed according to the change of shape of the optical disk of the optical disk apparatus according to one embodiment of the invention.

### DETAILED DESCRIPTION OF THE INVENTION

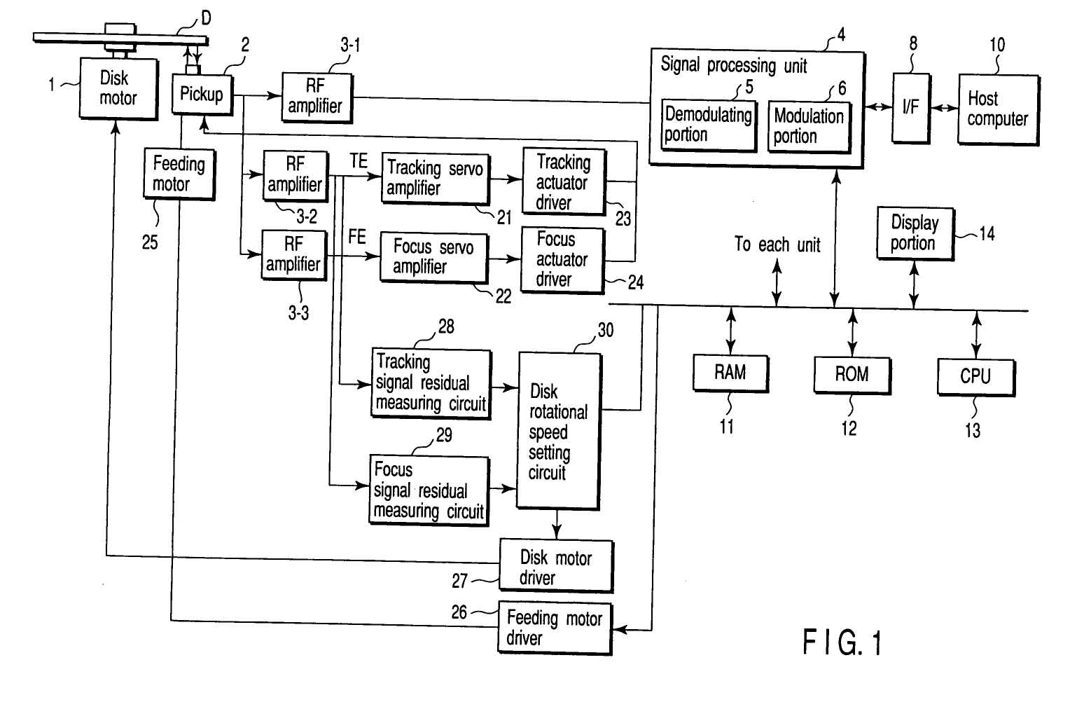

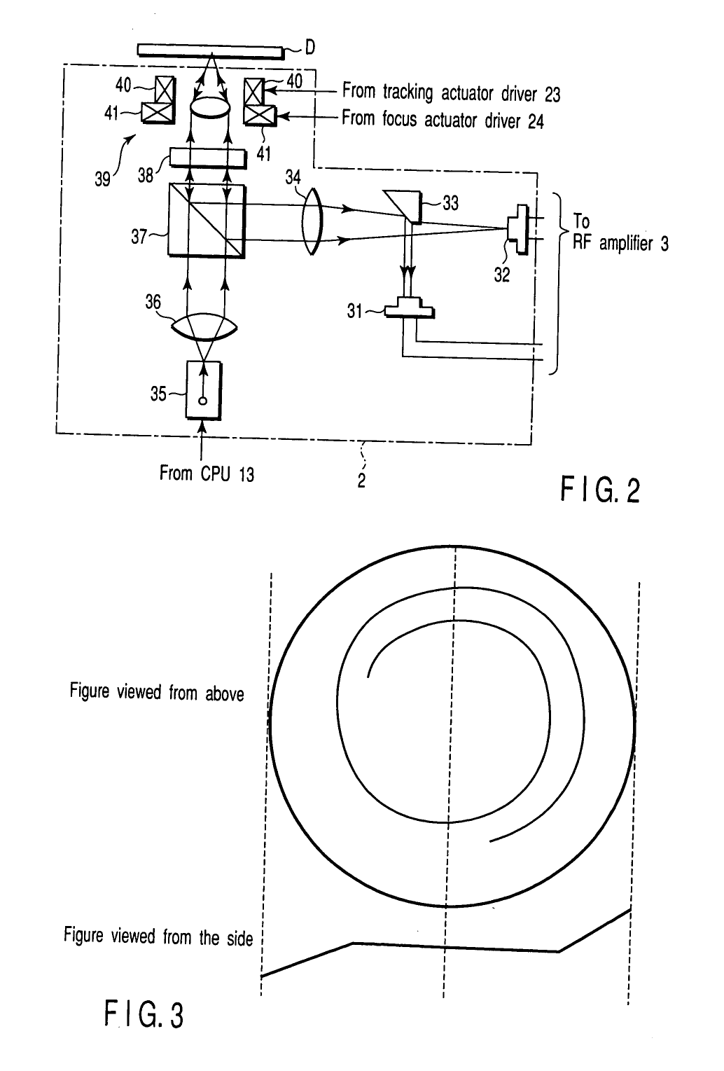

An optical disk apparatus according to one embodiment of the invention will be described below referring to the accompanying drawings. FIG. 1 is a block diagram showing an example of the optical disk apparatus according to one embodiment of the invention, and FIG. 2 is a sectional view showing an example of a constitution of an optical pickup device in the optical disk apparatus according to one embodiment of the invention.

<Constitution of Optical Disk Apparatus>

In the optical disk apparatus according to one embodiment of the invention of FIG. 1, a signal read from a disk D, which is driven by a disk motor 1, with an optical pickup 2 is supplied to RF amplifiers 3-1 to 3-3. The RF amplifier 3-1 supplies an RF signal, which is amplified from an output of the optical pickup 2, to a demodulating portion 5 in a signal processing unit 4. The RF amplifier 3-2 extracts a focus error signal FE to supply it to a tracking servo amplifier 21, and the RF amplifier 3-3 extracts a tracking error signal TE to supply it to a focus servo amplifier 22. Further, a control signal supplied from the tracking servo amplifier 21 is supplied to a tracking actuator driver 23, and the control signal supplied from the focus servo amplifier 22 is outputted to a focus actuator driver 24. The output of each of the drivers 23 and 24 is returned to the optical pickup 2, and supplied to a driving coil in track direction 40 and a driving coil in focus direction 41, which are described later. The output drives the driving coils 41 and 42 to perform servo control.

The signal processing unit 4 includes the demodulating portion 5 and a modulating portion 6. Under control conditions of a control portion performed with CPU 13, RAM 11, and ROM 12, the demodulation portion 5 demodulates the signal, which is detected by the optical pickup 2 and properly amplified by the RF amplifier 3-1 to be supplied, to a reproducible signal mode and supplies it to, e.g., a processing device of an external host computer 10 through an interface 8. The modulating portion 6 included in the processing unit 4 modulates, e.g., the signal given from the external host computer 10 through the interface 8 to the signal mode which can be recorded in the optical disk D. The modulated signal is reflected in a laser beam emitted from a semiconductor laser 35, which is described later, in the optical pickup 2 through the RF amplifier 3-1, a predetermined region of the optical disk is irradiated with the laser beam, and the signal is recorded as the reproducible information in the predetermined region.

The control portion performs operating determination by the CPU 13 corresponding to an operating program stored in the RAM 11 and ROM 12, and controls a whole procedure referring to the information from each unit.

It is also preferable to provide a display portion 14 displaying information concerning the operating information or the shape of the disk. It may be also preferable that the information concerning the operating information or the shape of the disk is displayed on the display portion of the host computer 10 through the interface 8 instead of the display portion 14.

The interface 8 controls communication concerning the interface such as various operating commands and data transmission and reception between the host computer 10 and the control portion. The operating command is exchanged between the control portion and the host computer 10 through the interface 8. However, the optical disk apparatus may be controlled by an operation panel (not show) and it is not always limited to this mode.

In FIG. 2, the pickup device 2 also has an actuator 39 holding an objective lens. The actuator 39 is provided with the actuator driving coil in track direction 40 and the actuator driving coil in focus direction 41, servo control can be performed by supplying driving current from the tracking actuator driver 23 and the focus actuator driver 24 to the actuator driving coils 40 and 41, respectively.

The pickup device 2 performs both irradiation and reception of light by a function of a beam splitter 37 or the like. The laser beam emitted from the semiconductor laser 35 corresponding to the control of the CPU 13 is passed through the beam splitter 37 and condensed with the objective lens through a quarter-wave plate 38, and the predetermined region of the optical disk D is irradiated with the laser beam. The reflected light from the optical disk D is extended with the objective lens, separated with the beam splitter 37 toward a condenser lens 34 side, and supplied to a photodiode 31 and a photodiode 32 with a reflecting mirror 33. In the photodiode 31, the tracking error signal is measured by a comparator (not shown) and supplied to the tracking servo amplifier 21 and the focus servo amplifier 22. In the photodiode 32, the focus error signal is measured with the comparator (not shown), supplied to the tracking servo amplifier 21, and supplied simultaneously to the RF amplifier 3-1 for generation of the reproducing signal.

The tracking error signal TE outputted from the RF amplifier 3-2 is supplied to a tracking signal residual measuring circuit 28, and the tracking error signal FE outputted from the RF amplifier 3-3 is supplied to a focus signal residual measuring circuit 29. The output of the tracking signal residual measuring circuit 28 and the output of the focus signal residual measuring circuit 29 are supplied to a disk rotational speed setting circuit 30.

The disk rotational speed setting circuit 30 receives the control signal from the CPU 13, considers a residual signal of the focus error signal and the residual signal of the tracking error signal, and outputs the control signal to a disk motor driver 27.

As described above, the optical disk apparatus according to one embodiment of the invention detects and reproduces the storage information stored in the storage area on the optical disk, and performs the modulating operation on the basis of the given signal and stores the information in the storage area on the optical disk.

(Rotational Speed Control of Optical Disk in Optical Disk Apparatus)

In the above-described constitution, the optical disk apparatus according to one embodiment of the invention performs the recording processing without impairing reliability for the distortion of the optical disk in a manner that performs the characteristic control of rotational speed of the optical disk.

That is, the optical disk apparatus according to one embodiment of the invention relates to a method of controlling recording speed, e.g., in the recordable optical disk apparatus represented by CD-R or CD-RW. In the recordable optical disk such as CD-R, because of bad quality of the medium shape, sometimes there is the case of the failed recording unless the recording speed is decreased. In the invention, the quality of the medium shape is measured during the recording and the recording speed is decreased before recording performance is degraded, so that the recording quality is maintained.

The mechanical shape of the removable medium such as an optical disk is rarely an ideal plate, there are many disks having the distortion. When the medium having such a shape is recorded at a higher double-speed, since the servo can not follow with sufficient accuracy, sometimes the recording is failed by deviating out the track. Even if the servo is off-track, a converging state of a recording light spot exceeds a permitted value and becomes a defocusing state, and a sharp mark can not be formed. For a solution to these problems, it is effective that the recording speed is decreased and the tracing state of the servo is recovered.

However, when the recording speed is indiscriminately decreased, even if recording stability can be secured, convenience of users is remarkably reduced by the decrease in the recording speed, so that the recording speed should be decreased only in a minimal situation. Therefore, it is essential to measure easily and precisely the disk shape. Further, even if the shape is simply measured only in part of the disk, since there is also the medium in which the mechanical shape is normal at the inner radius and is worsened on the way, the method in which the medium shape is measured in real time during the recording is desired.

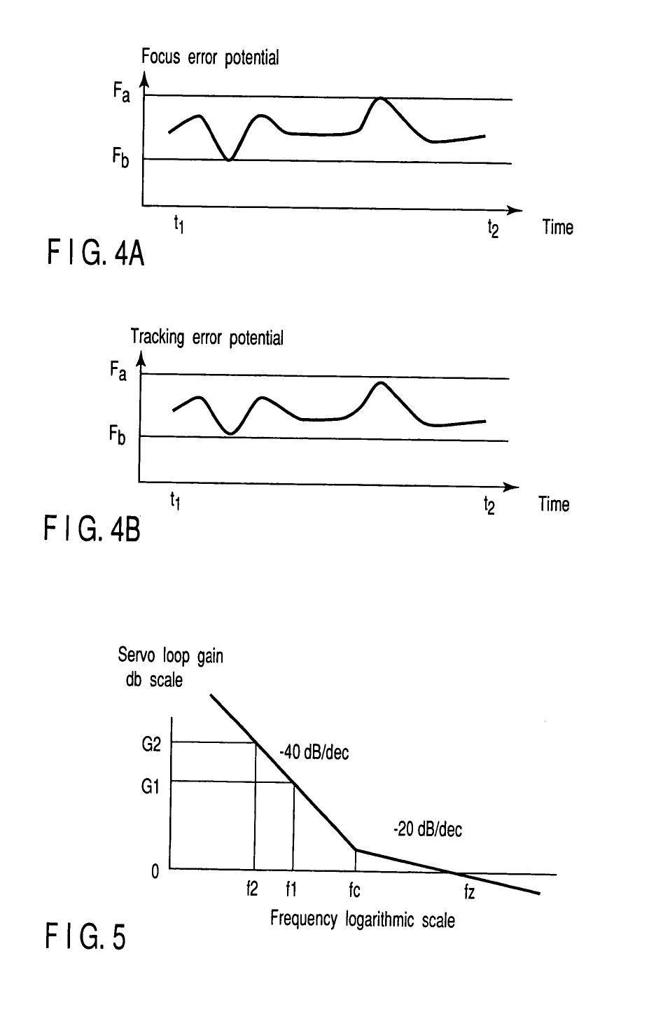

FIG. 3 shows an example of the distorted disk. There is the warp in the outer radius portion, and its runout component is the value which the servo system can not permit. FIG. 4A is an example of the waveform of the focus error signal, which can be observed while the recording is performed into the disk shown in FIG. 3, a time between t1 and t2 corresponds to one revolution of the disk. This wave in the figure is the residual which the servo leaves and the value corresponding to the distortion of the disk. The amount of the runout of the disk can be estimated by measuring a peak value (Fₐ−F_{b}) of an AC component of the error signal. Similarly, FIG. 4B is an example of the waveform of the tracking error signal, which can be observed while the recording is performed into the disk shown in FIG. 3.

When the peak value exceeds a proper slice level, the stability of the recording operation is achieved by decreasing the recording speed to the previously set value. It is rare in the disk shape that the large distortion point suddenly emerges without a harbinger, but it is normal that the distortion begins gradually and the servo trace finally reaches the unstable state. Accordingly, the slice level can be set with a sufficient margin for a servo limit.

The focus servo residual is the value in which the amount of the runout of the disk is divided by a focus servo open loop gain at the frequency component. Citing an example of the configuration of the focus servo system with FIG. 5, the open loop gain can be designed so as to have a gradient of −40 dB/dec in the range from DC to fc and have the gradient of −20 dB/dec above the frequency fc. The gain becomes one time at the frequency fz, and the gain does not follow above the frequency fz. In such servo system, for example, there is the following relation between the gain G1 at the frequency f1 and the gain G2 at the frequency f2.

G2=(f1/f2)2*G1

Accordingly, when the frequency is decreased, the gain is increased in inverse proportion to a square. Namely, when the number of revolutions is decreased, the servo leaving amount can be decreased in inverse proportion to the square. The residual is lessened in inverse proportion to the frequency in the range from fc to fz.

The focus signal residual measuring circuit 29 shown in FIG. 1 detects and outputs the focus residual signal. The focus residual signal is obtained by performing a certain processing to the focus error signal FE, and the focus residual signal includes, e.g., a pp value or average electric power P, which is described later. In the invention, the focus servo circuit is operated by the focus error signal detected from the pickup 2, and feedback of the driving signal is performed to a focus actuator in the pickup. Almost as soon as the drive starts the recording operation, the focus error signal is inputted to the residual measuring circuit 29, the signal is transmitted to the disk rotational speed setting circuit 30 when the focus residual signal exceeds a predetermined threshold value, the proper control signal is generated, and the control signal is supplied to the disk motor driver 27 to be controlled, which allows the number of revolutions of the spindle motor to be changed to a predetermined value.

In a method of determining the focus residual signal of the focus signal residual measuring circuit 29 (or tracking signal residual measuring circuit 28), it is possible that the peak value and the bottom value of the signal are measured over an interval of at least one round and difference (pp value) between the peak and bottom values is set to the focus residual signal. This method has a feature that the focus residual signal can be correctly detected even if there is the partial distortion in the disk.

With reference to another method of determining the focus residual signal, the average electric power P of the focus error signal (tracking error signal) is measured by the following equation and used for determining the focus residual signal:

P=(x₁²+x₂²+ . . . +xₙ²)/n

where xₙ is a time series value. In this method, there is the feature which is hardly affected a flaw on the disk or the like.

When the focus signal residual measuring circuit 29 (tracking signal residual measuring circuit 28) exceeds the predetermined threshold value, the number of revolutions is decreased in the disk rotational speed setting circuit 30.

In the optical disk apparatus according to one embodiment of the invention, though determination of the decrease in the speed is made by determining the change in the focus error signal as described above, the same function and effect are also obtained in a way to decrease the number of revolutions of the optical disk by making the determination with the disk rotational speed setting circuit 30 on the basis of the change in the tracking error signal from the tracking signal residual measuring circuit 28. As can be seen form comparison between FIG. 4A and FIG. 4B, this is because the problem of the servo, which is based on the distortion of the optical disk, can be also detected by observing the tracking error signal. Particularly the runout component can be detected with the focus error signal and fluctuation in the radial direction can be detected with the tracking error signal.

It is possible in practical that the decrease in the speed is controlled only by the focus error signal or the tracking error signal, and, combining both the focus error signal and the tracking error signal, the determination is performed when the one of the both or the both exceed the threshold value. Accordingly, in the optical disk apparatus according to one embodiment of the invention, the rotational speed during the recording processing can be controlled in the case where only the focus error signal is referred, the case where only the tracking error signal is referred, and the case where the both are referred respectively.

(Various Settings of Rotational Speed)

As described below, various methods of changing the speed are effective in the disk rotational speed setting circuit 30.

In the optical disk, the recording processing of the information is performed corresponding to a given recording command. One of the changing methods of the speed is to return the predetermined recording speed in each recording unit in which the recording processing is performed corresponding to the recording command. Even if the recording speed is decreased in a certain recording unit corresponding to the state of the disk, when the next recording command is received, re-setting is performed to the original recording speed. In the disk in which the distortion exists only in a part, high-speed recording can be performed in the disk as a whole, because the decrease in the recording speed is limited only in the part.

Moreover, the method of changing the speed, in which the predetermined recording speed is given for one optical disk, is effective. In this case, when the recording speed is previously set at the lower recording speed, the next recording processing is also performed at the lower recording speed in such a manner that the optical disk apparatus detects servo state of the disk. This controlling operation is performed by the processing of the CPU 13 and the like in the control portion and the disk rotational speed setting circuit 30. Consequently, the fact that the reproducing speed is often changed in the one optical disk is eliminated, so that the stable reproducing processing can be obtained.

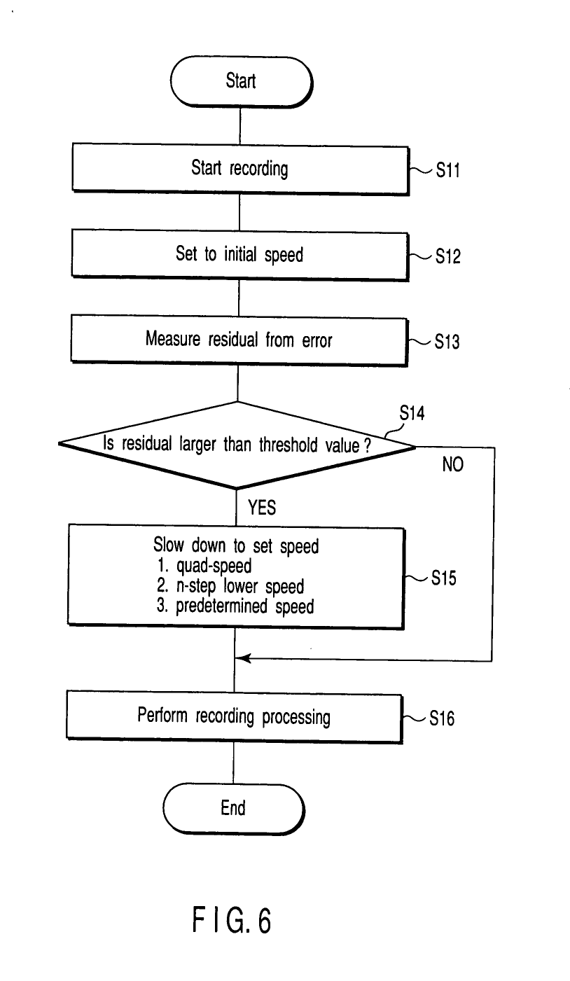

Accordingly, various speed settings shown below are effective in the disk rotational speed setting circuit 30. FIG. 6 is the flow chart in the case where the number of revolutions is changed corresponding to the change of shape of the optical disk of the optical disk apparatus according to one embodiment of the invention, the description is done below corresponding to the flow chart. In the optical disk apparatus according to one embodiment of the invention, when the recording processing is started by receiving the recording command (S11), at first the recording processing is performed by setting the initial speed which is given by the ROM 12 or the like (S12). While the recording processing is performed, the residual of the error signal is supplied from the focus signal residual measuring circuit 29, the tracking signal residual measuring circuit 28, or the both to the disk rotational speed setting circuit 30 (S13), the determination is performed whether or not the residual of the error signal to be considered is larger than the threshold value (S14). At this point, as described above, the method in which the residual is calculated by the pp value or the method in which the residual is calculated by the average electric power P is taken for performing the determination. When the residual is not more than the threshold value, the recording processing is carried on at the rotational speed which is set initially. This processing routine is repeatedly executed during the recording operation.

However, when the residual more than the threshold value is detected, the predetermined change in the speed is performed. That is, 1) quad-speed, 2) n-step lower speed, and 3) predetermined speed are available.

1) The quad-speed is to change the speed to the slowest speed, and the stable reproducing is secured because the speed is always reproducible in any reproducing device.

2) The n-step lower speed means that, for example, the change in the speed is set to the speed which is the 2-step lower speed than the previous speed in the standard speed of the usual optical disk apparatus such as quad-speed, 8-fold speed, 12-fold speed, 20-fold speed, and 24-fold speed. That is, in the case where the current speed is 24-fold speed, when the change in the speed is set to the 2-step lower speed, the speed is changed to the 16-fold speed. Similarly, when the change in the speed is performed from the 12-fold speed to the 2-step lower speed, the change in the speed means that the speed is changed to the quad-speed.

3) The predetermined speed is the set speed to which the speed is changed when the change in the speed is previously performed. That is, it is the case in which the change to the 8-fold speed is set from the operating panel or the host computer in the quad-speed, the 8-fold speed, the 12-fold speed, the 20-fold speed, and the 24-fold speed. It is also possible to designate the speed except the quad-speed, the 8-fold speed, the 12-fold speed, the 20-fold speed, and the 24-fold speed.

After the change in the speed is performed as described above, the recording processing is performed at the changed speed (S16).

Alternatively, it is also preferable to adopt the method in which the decrease in the speed of a certain rate, e.g., 10% is performed at the stage in which the error measured value exceeds the threshold value, and the error residual is measured again. When the measured value becomes the threshold value of −α, the recording is continued while the state is maintained. Where α is the value more than zero. When the measured value exceeds the threshold value of −α, the decrease in the speed of the same rate is further set and the error residual is measured again. The operation is repeated until the measured value falls below the threshold value of −α. According to the method, the decrease in the recording speed is minimal and the decrease of the recording performance can be suppressed.

The wave measurement of utmost one round is enough for the detection of the AC component in each signal. Since the measurement can be repeated at high speed, high detection resolution can be taken in the region of the disk distortion and the region of the decrease in the speed can be suppressed to a minimum.

The degree of the distortion of the optical disk can be displayed on the display portion 14 which is the operation panel of the optical disk apparatus or can be informed to the host computer through the interface 8 on the basis of the residual signal by the function of the disk rotational speed setting circuit 30 and CPU 13 in the control portion. Consequently, it can be avoided that the user misunderstands that failure occurs by the sudden change in the speed.

Though a person skilled in the art can realize the invention by the various embodiments described above, various modifications of the embodiments can be easily conceived by a person skilled in the art, and the invention can be applied to various modes without any inventive ability. Accordingly, the invention covers a wide range which is not contradictory to the disclosed principle and novel feature, and it is not limited to the above-described embodiments.

As described in detail above, the invention provides the optical disk apparatus and the method of controlling the optical disk rotational speed, in which the recording processing can be performed with high quality while the recording characteristics of the optical disk apparatus are prevented from degrading in such a manner that the quality of the disk shape is measured during the recording and the recording speed is reduced before the recording performance is decreased.

What is claimed is:

1. An optical disk apparatus comprising:
a rotating motor which rotates the optical disk at a predetermined speed;
a recording portion which irradiates the optical disk with a laser beam generated corresponding to given information to perform recording processing;
a measuring circuit which measures a focus error signal caused by irradiating the optical disk with the laser beam;
a determination portion which determines whether or not the predetermined speed of the rotating motor is decreased on the basis of a value obtained from the focus error signal measured by the measuring circuit; and
a speed control portion which decreases the predetermined speed of the rotating motor corresponding to the value determined by the determination portion.

2. The optical disk apparatus according to claim 1, wherein the speed control portion controls the predetermined speed of the rotating motor so as to decrease the predetermined speed of the rotating motor, when difference between a peak value and a bottom value of the focus error signal measured by the measuring circuit is more than a threshold value.

3. The optical disk apparatus according to claim 1, wherein the speed control portion controls the predetermined speed of the rotating motor so as to decrease the predetermined speed of the rotating motor, when an average electric power value of the focus error signal measured by the measuring circuit is more than the threshold value.

4. The optical disk apparatus according to claim 1, wherein the measuring circuit measures the focus error signal and the tracking error signal which are caused by irradiating the recording portion with the laser beam, and
the speed control portion controls the predetermined speed of the rotating motor on the basis of values of the focus error signal and the tracking error signal which are measured by the measuring circuit so as to decrease the predetermined speed of the rotating motor.

5. The optical disk apparatus according to claim 1, wherein the speed control portion controls the predetermined speed of the rotating motor on the basis of the value of the focus error signal measured by the measuring circuit so as to decrease the predetermined speed of the rotating motor in each given command of the recording processing.

6. The optical disk apparatus according to claim 1, wherein the speed control portion controls the predetermined speed of the rotating motor on the basis of the value of the focus error signal measured by the measuring circuit so as to decrease the predetermined speed of the rotating motor in each optical disk.

7. The optical disk apparatus according to claim 1, wherein the speed control portion controls the predetermined speed of the rotating motor on the basis of the value of the focus error signal measured by the measuring circuit so as to decrease the predetermined speed of the rotating motor to quad-speed.

8. The optical disk apparatus according to claim 1, wherein the speed control portion controls the predetermined speed of the rotating motor on the basis of the value of the focus error signal measured by the measuring circuit so as to decrease the predetermined speed of the rotating motor to an n (integer number)×lower speed than a current speed among the 4× speed, 8× speed, 12× speed, 20× speed, and 24× speed.

9. The optical disk apparatus according to claim 1, wherein the speed control portion further has a setting portion which previously sets a set speed, and controls the predetermined speed of the rotating motor on the basis of the value of the focus error signal measured by the measuring circuit so as to decrease the predetermined speed of the rotating motor to the set speed set by the setting portion.

10. The optical disk apparatus according to claim 1, further comprising:
a display portion which displays information concerning a shape of the optical disk on the basis of the value of the focus error signal measured by the measuring circuit.

11. An optical disk apparatus comprising:
a rotating motor which rotates the optical disk at a predetermined speed;
a recording portion which irradiates the optical disk with a laser beam generated corresponding to given information to perform recording processing;
a measuring circuit which measures a tracking error signal caused by irradiating the optical disk with the laser beam;
a determination portion which determines whether or not the predetermined speed of the rotating motor is decreased on the basis of a value obtained from the tracking error signal measured by the measuring circuit; and
a speed control portion which decreases the predetermined speed of the rotating motor corresponding to the value determined by the determination portion.

12. The optical disk apparatus according to claim 11, wherein the speed control portion controls the predetermined speed of the rotating motor so as to decrease the predetermined speed of the rotating motor, when difference between a peak value and a bottom value of the tracking error signal measured by the measuring circuit is more than a threshold value.

13. The optical disk apparatus according to claim 11, wherein the speed control portion controls the predetermined speed of the rotating motor so as to decrease the predetermined speed of the rotating motor, when an average electric power value of the tracking error signal measured by the measuring circuit is more than the threshold value.

14. A method of controlling an optical disk rotational speed, comprising:
rotating an optical disk at a predetermined speed;
irradiating the optical disk with a laser beam generated corresponding to given information to perform recording processing;
measuring a focus error signal caused by the irradiation with the laser beam in the recording; and
controlling the predetermined speed in the rotating on the basis of a value of the focus error signal so as to properly decrease the predetermined speed.
